(19) United States
(12) Patent Application Publication
(10) Pub. No.: US 2012/0159403 A1
(43) Pub. Date: Jun. 21, 2012

(54) SYSTEM AND METHOD FOR GAUGING AND SCORING AUDIENCE INTEREST OF PRESENTATION CONTENT

(75) Inventor: Faruk M. Capan, Overland Park, KS (US)

(73) Assignee: INTOUCH SOLUTIONS, INC., OVERLAND PARK, KS (US)

(21) Appl. No.: 12/972,910

(22) Filed: Dec. 20, 2010

(51) Int. Cl. G06F 3/033; G06F 17/30

(52) U.S. Cl. 715/863; 707/748; 707/E17.044

(57) ABSTRACT

A system and method for managing content displayed in media presentations. A client computing device includes a client media presentation application that is responsive to feedback input received during the display of one or more slides of a media presentation to assign a score to each of the one or more slides. The media presentation application stores the assigned scores in a client database as media presentation data. A server computing device includes a server database that stores media presentation data. The server computing device also includes a server media presentation application that communicates with the client media presentation application during a synchronization process to synchronize media presentation data between the client database the server database.

### RELATED APPLICATIONS

Not Applicable.

### FEDERALLY SPONSORED RESEARCH OR DEVELOPMENT

Not Applicable.

### COMPACT DISK APPENDIX

Not Applicable.

### BACKGROUND

Software applications have been developed for computer systems that enable user to create and display media presentations, such as a slide show to an audience. Typically, a media presentation includes a collection of content, such as images, text, charts, graphs, or other content that is displayed in a slide show format to provide information about a particular topic, object, and/or product to the audience. When preparing the media presentation, the author or designer will select content that is expected to maximize the effectiveness of and/or the audience interest in the media presentation. Ultimately, the effectiveness of a particular media presentation depends on how that particular presentation is received by the audience.

The presenter can usually gauge the effectiveness of the presentation and/or the audience's interest during the presentation. In particular, because the presenter can observe the audience, the presenter can discern whether or not a particular presentation is being received in a positive manner by the audience. Conventional media presentation applications enable an author and/or presenter to modify the content included a particular media presentation that based on past presentations of such content. For example, some media presentation applications allow a presenter to manipulate slide show features, and/or insert slides to enhance the experience of the audience. However, conventional media presentation applications do not enable a presenter to assign scores to content included in media presentation and to store the assigned scores during the presentation.

### SUMMARY

According to one aspect, a portable computing device encoded with a media presentation application is provided. The media presentation application comprising modules executable by a processor to rank content in a media presentation. The media presentation application includes a retrieval module to retrieve a media presentation stored in a database in response to a presentation request generated at the portable computing device. The media presentation includes a plurality of pages that each includes content. The presentation request includes identification data that corresponds to the media presentation.

The media presentation application also includes a display module to display each of the plurality of pages of the media presentation via a graphical interface of the portable computing device. The media presentation application also includes a scoring module to assign a score to at least one of the plurality of pages of the media presentation in response to a feedback input received at the graphical interface while the at least one of the plurality of pages is being displayed. The feedback input specifies the score for the at least one of the plurality of pages and corresponds to a directional movement of an input tool at the graphical interface.

The media presentation application also includes a storage module to store the score assigned to the at least one of the plurality of pages in the database. The media presentation application also includes a synchronization module to transmit the score assigned to the at least one of the plurality of pages to a remote computing device in response to a synchronization request generated at the portable computing device.

According to another aspect, a method is provided for ranking content in a media presentation. The method includes generating a presentation request at a portable computing device. The presentation request includes identification data corresponding to a media presentation. The method also includes retrieving the media presentation from a database in response to the presentation request. The media presentation includes a plurality of pages that each includes content. The method includes also includes displaying each of the plurality of pages of the media presentation via a graphical interface of the portable computing device. The method includes receiving a feedback input at the graphical interface while a particular one of least one of the plurality of pages is being displayed. The feedback input specifies a score for that particular one of the pages and corresponding to a directional movement of an input tool at the graphical interface. The method includes storing the score specified for the particular one of the pages in the database. The method also includes transmitting the score for the particular one of the pages to a server in response to a synchronization request generated at the portable computing device.

According to another aspect, a computer-readable medium encoded with a media presentation application is provided. The media presentation application comprising modules executable by a processing device to rank content in a media presentation. The media presentation application includes a retrieval module to retrieve a media presentation stored in a database in response to a presentation request generated at the processing device. The media presentation includes a plurality of pages that each includes content. The presentation request includes identification data that corresponds to the media presentation.

The media presentation application also includes a display module to display each of the plurality of pages of the media presentation via a graphical interface of the processing device. The media presentation application also includes a scoring module to assign a score to at least one of the plurality of pages of the media presentation in response to a feedback input received at the graphical interface while the at least one of the plurality of pages is being displayed. The feedback input specifies the score for the at least one of the plurality of pages and corresponds to a directional movement of an input tool at the graphical interface.

The media presentation application also includes a storage module to store the score assigned to the at least one of the plurality of pages in the database. The media presentation application also includes a synchronization module to transmit the score assigned to the at least one of the plurality of pages to a remote computing device in response to a synchronization request generated at the processing device.

### BRIEF DESCRIPTION OF THE DRAWINGS

FIG. 1 is a block diagram of a computing environment for displaying and managing media presentations according to one aspect of a media presentation system.

FIG. 2A is screen shot of an authentication form according to one aspect of the media presentation system.

FIG. 2B is screen shot of a member selection form according to one aspect of the media presentation system.

FIG. 2C is screen shot of slide according to one aspect of the media presentation system.

FIG. 2D is screen shot of a presentation history form_according to one aspect of the media presentation system.

FIG. 3 is a block diagram of a client media presentation application according to one aspect of the media presentation system.

FIG. 4 is a block diagram of a server media presentation application according to one aspect of the media presentation system.

FIG. 5 illustrates a method for managing a media presentation data and/or audience profile data on a client according to one aspect of the media presentation system.

FIG. 6 illustrates a method for displaying and scoring a media presentation according to one aspect of the media presentation system.

FIG. 7 illustrates a method for initiating a synchronization process between the client and server according to one aspect of the media presentation system.

FIG. 8 illustrates a method for managing a media presentation data and/or audience profile data on a server according to one aspect of the media presentation system.

### DETAILED DESCRIPTION

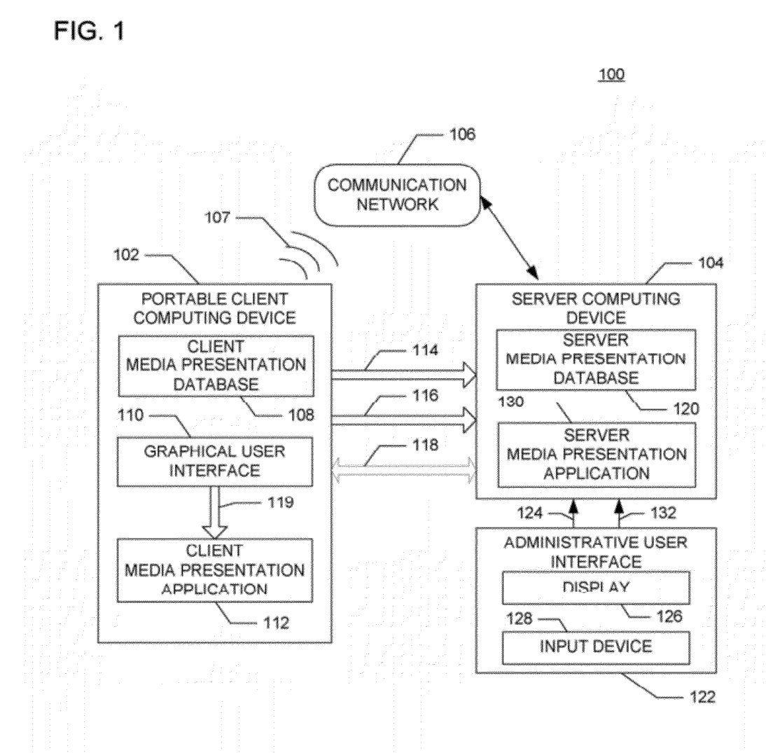

FIG. 1 is a block diagram of a media presentation system 100 for displaying and managing media presentations. The media presentation system 100 includes a portable client computing device 102, a server computing device 104, and a communication network 106 to enable data communication between the client computing device (“client”) 102 and the server computing device (“server”) 104. According to one aspect, the client 102 is a portable computing device, such as a lap top computer, a personal digital assistant, or a portable media player, such as an iPAD® manufactured by Apple, Inc. of Cupertino, Calif. It is contemplated that in other embodiments, the client 102 is, for example, a standard personal computer. The communication network 106 can be the Internet, an intranet, or another communication network. In this example, the client 102 and the server 104 may communicate data among themselves via a wireless communication signal, as indicated by reference character 107, using a Wireless Application Protocol (WAP) which is a protocol commonly used to provide Internet service to digital mobile phones and other wireless devices.

The client 102 includes a client media presentation database (“client database”) 108 that stores media presentation data including one or more media presentations. A media presentation includes content, such as a series of slides or pages that are displayed to one or more members of an audience to provide information about a topic and/or a product. As one example, the user may be a sales representative for a pharmaceutical company and the one or members of the audience may include physicians that prescribe or are contemplating describing a particular medication. As another example, the user can be an educator and the one or more members of the audience may include students and/or colleagues of the educator. As yet another example, the user can be a physician and the one or more members of the audience may include patients of the physician. Other examples exist.

The client database 108 also stores audience profile data for audience members, such as contact data, professional data, and preference data for individual audience members. Contact data may include first name, last name, email address, phone number, mailing address, and any other contact information. Professional data may include employer's name, job title, degree(s), awards, and any other professional information. Preference data may include nick names, product preferences, available meeting times, and any other preference data.

Moreover, as known to those skilled in the art, a database includes records that may have one or more data fields. In this example, the client database 108 includes a plurality of records and each record identifies at least one media presentation and audience profile data associated with that at least one media presentation. For example, a particular media presentation my be associated with one or more audience member's names and/or professions.

The client 102 includes a graphical user interface 110 that enables a user to interact with a client media presentation application (“client MPA”) 112 to retrieve and display a particular media presentation stored in the client database 108. The graphical user interface 110 includes a display, such as a screen for viewing media presentations, media presentation data, and/or input forms. The graphical user interface 110 also includes an input device, such as a keypad or a pointing device (e.g., a mouse, trackball, stylus, or touch screen), for entering media presentation data and/or audience profile data.

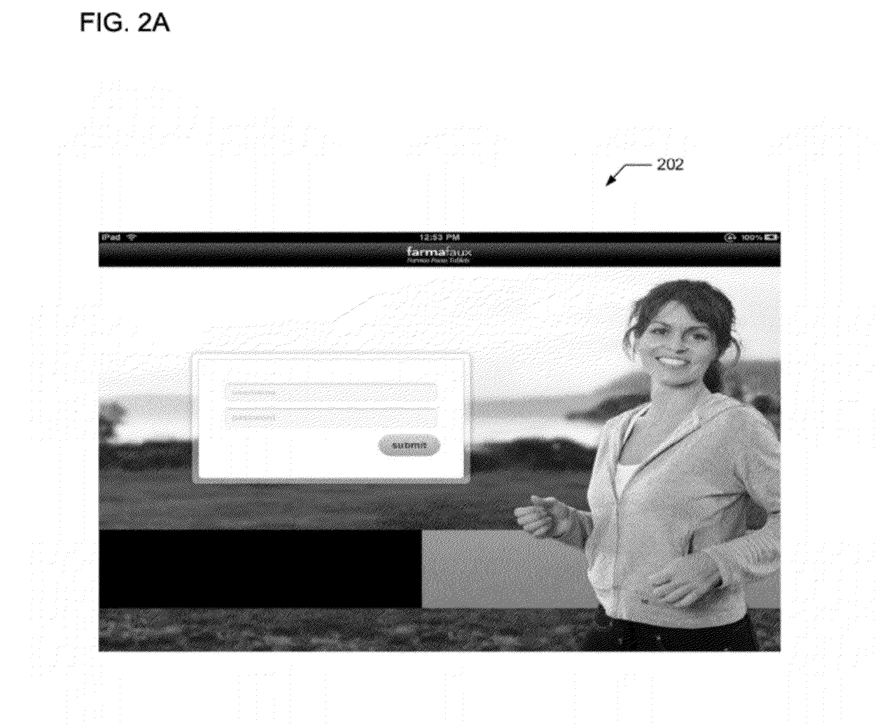

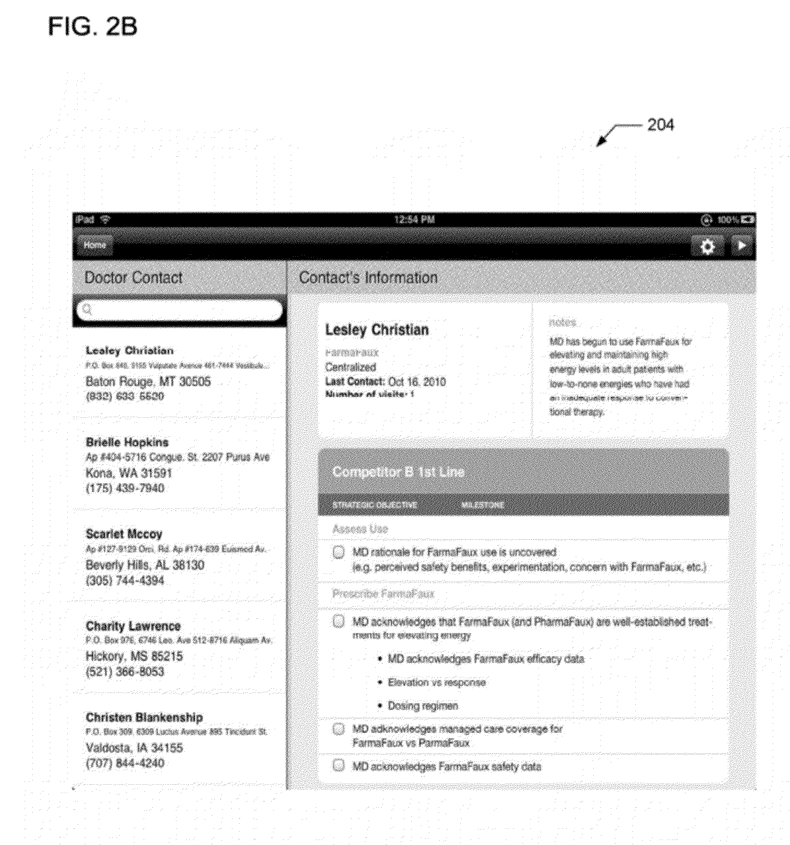

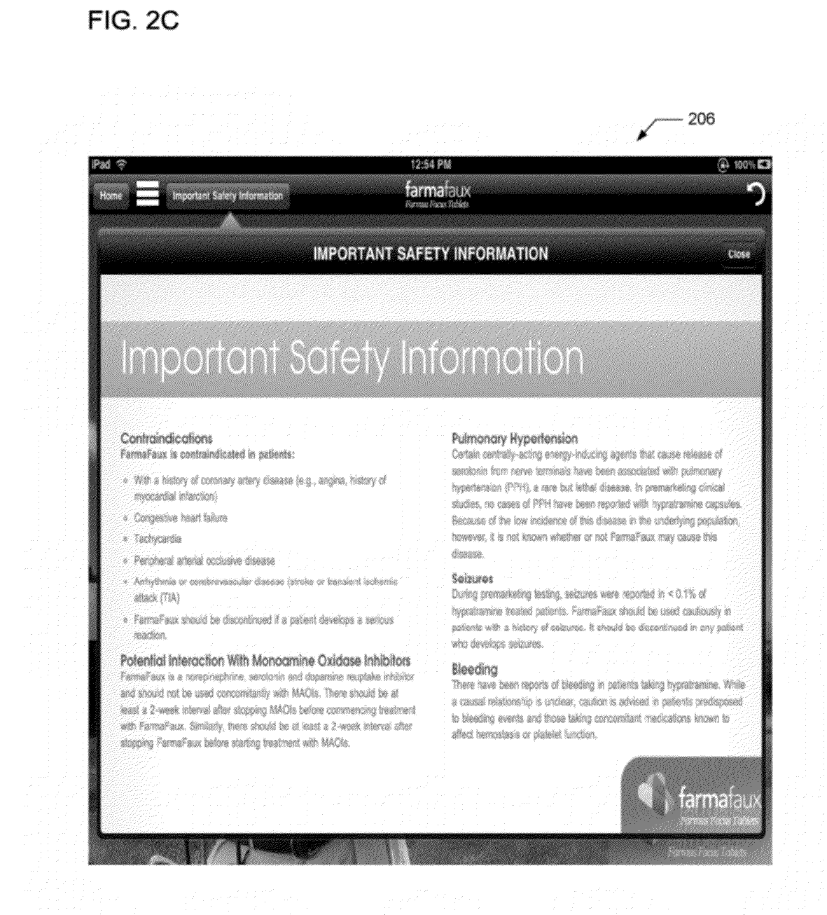

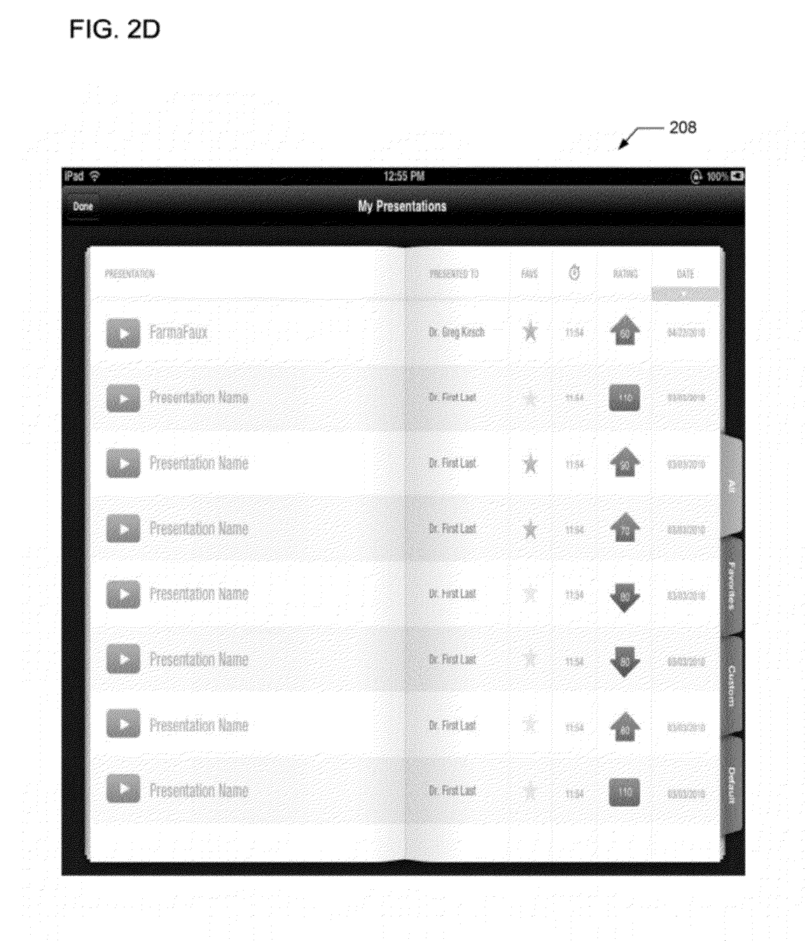

According to one aspect, before the user can access the media presentation data and/or the audience profile data, the user of the client 102 interacts with the graphical user interface 110 to generate an authentication request 114. The authentication request 114 is generated, for example, by a user interacting with the graphical user interface 110 to input user authentication data, such as a username and/or a password into an authentication or login form displayed on the screen. A screen shot of an exemplary authentication form 202 is depicted in FIG. 2A. The client MPA 112 transmits the authentication request 114 to the server 104 for authentication.

If the authentication request 114 is determined to correspond to an authorized user at the server 104, the client MPA 112 generates and transmits a synchronization request, as indicated by 116, to the server 104 to synchronize media presentation data and audience profile data between the client and the server. Synchronization is a process for updating and maintaining coherence between copies of a dataset that is maintained in different storage locations (e.g., client 102 and sever 104). According to one aspect, a push then pull data synchronization process, as indicated by 118, is used. The push/pull process 118 involves first sending updates from the client 102 to the server 104 and then receiving updates from the server 104. According to one aspect, the client MPA 112 automatically generates the synchronization request 116 upon authentication of the authentication request 114 at server 104. In an alternative aspect, the client MPA 112 generates and transmits the synchronization request 116 in response to user input received via the graphical user interface 110.

After authentication and/or synchronization, the user of the client 102 interacts with the graphical user interface 110 to generate a presentation request 119. The presentation request 119 is generated, for example, by the user interacting with the graphical user interface 110 to input profile data for a particular audience member into an audience member selection form being displayed on the screen. A screen shot of an exemplary audience member selection form 204 is depicted in FIG. 2B. The client MPA 112 retrieves a particular media presentation from the client database 108 for display in response to the presentation request 119.

The content included on a particular slide or page of a media presentation may include text, images, and/or information graphics, such as a graph or chart that includes numeric data. For example, at least one slide included in a presentation about a particular pharmaceutical product, may include safety information that is required to be disclosed to an audience viewing the presentation. A screen shot of exemplary slide 206 displaying safety information is depicted in FIG. 2C. At least one other slide in the same presentation may include a chart that illustrates statistics regarding the effectiveness of the particular pharmaceutical product as compared to similar pharmaceutical products.

During the display of each slide of a media presentation, the client MPA 112 detects whether feedback input is received at the client 102. As used herein, feedback input corresponds to an input that indicates the user's impression of how the content on a particular slide or page of the media presentation is received by an audience member. According to one aspect, the feedback input corresponds to a directional movement of an input tool, such as a finger or stylus, at the graphical interface. As explained in more detail below, the client MPA 112 assigns a score to each particular slide of the presentation based on the feedback input received while that particular slide is being displayed.

Although, the client MPA 112 is described herein as assigning a score to each particular slide of the presentation based on the feedback input received while that particular slide is being displayed, it is contemplated that in other aspects the client MPA 112 may assign multiple scores to a particular slide. For example, the client MPA 112 may assign scores to various portions of a particular slide based on feedback inputs received at each of the various portions of that particular slide while it is being displayed.

According to another aspect, the client MPA 112 calculates an overall score for the media presentation based on the scores assigned to each of the slides in that media presentation. The client MPA 112 then stores the scores assigned to each slide in the media presentation and/or the overall score for the media presentation in the client database 108 as media presentation data.

The server 104 includes a server media presentation database (“server database”) 120 that stores media presentation data including one or more media presentations. The server database 120 also includes audience profile data. According to another aspect, and as explained in more detail below, the client 102 communicates with the server 104 during the synchronization process 118 to transfer media presentation data and audience profile data to the server 104 and to receive media presentation data and audience profile data from the server 104.

An administrative user interface (UI) 122 may be coupled to the server 104 such that an administrator, or administrative user, of the server 104 may interact with the administrative UI 122 to generate an update request 124. As an example, the update request 124 is generated by the administrative user interacting with an administrative input form (not shown) to define media presentation data and/or audience profile data to add to the server database 120. As another example, the update request 124 is generated by the administrative user interacting with an administrative input to update media presentation data and/or audience profile data stored in the server database 120. The administrative UI 122 may include a display 126, such as a computer monitor, for viewing media presentation data and/or audience profile data and/or input forms, and an input device 128, such as a keyboard or a pointing device (e.g., a mouse, trackball, pen, or touch pad), for entering media presentation data and/or for entering audience profile data for a particular audience member into the administrative input form.

The server 102 executes a server MPA 130 in response to the synchronization request 116 to store updated media presentation and audience profile data received from the client 102 in the server database 120 and/or to transfer updated media presentation audience profile data from the server database 120 to the client 102. For example, the server MPA 130 stores scores assigned to pages in media presentations, overall scores of media presentations, and/or updated audience profile data received from the client 102 in the server database 120. As another example, the server MPA 130 transfers media presentation and audience profile data to the client 102 that have been updated or added by the administrative user.

According to another aspect, the server MPA 130 generates media presentation reports in response to a report request 132 received via the administrative UI 122. For example, the administrative user may interact with a report request form (not shown) to generate the report request 132. Media presentation reports include, for example, the scores assigned to pages in media presentations and overall scores of media presentations. Thereafter, the reports can be viewed by interested parties to determine whether the content (i.e., pages) included in a particular media presentation should be replaced, revised, or remain the same.

Although FIG. 1 illustrates a single client 102 communicating with the server 104, it is contemplated that multiple clients 102 can communicate and, thus, synchronize media presentation data and/or audience data with the server 104. As a result, the server 104 can aggregate score data (i.e., scores assigned to pages in media presentations and overall scores of media presentations) from multiple clients 102.

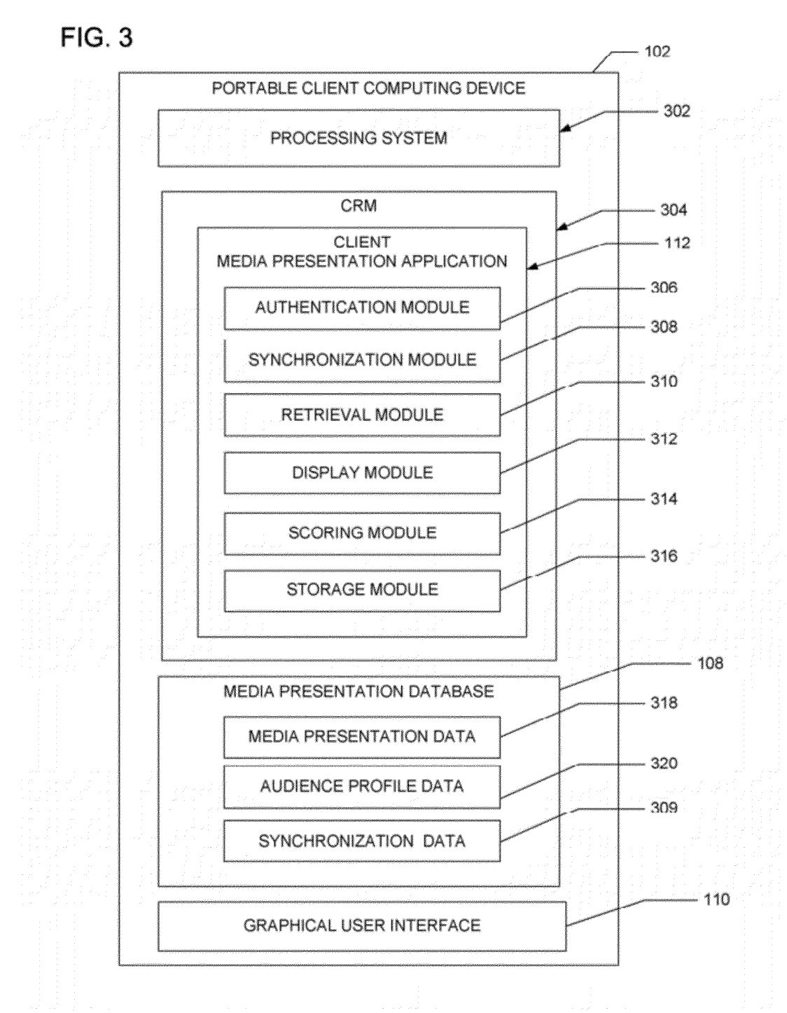

FIG. 3 is a block diagram that depicts an exemplary client MPA 112. According to one aspect, the client 102 includes a processing system 302 that includes one or more processors or other processing devices. The processing system 302 executes the client MPA 112 to display and manage media presentations.

According to one aspect, the client 102 includes a computer readable medium (“CRM”) 304 configured with the client MPA 112. The client MPA 112 includes instructions or modules that are executable by the processing system 302 to retrieve a media presentation for display, to assign scores to slides in the media presentation, and/or to assign an overall score to the media presentation.

The CRM 304 may include volatile media, nonvolatile media, removable media, non-removable media, and/or another available medium that can be accessed by the client 102. By way of example and not limitation, computer readable medium 304 comprises computer storage media and communication media. Computer storage media includes memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system.

An authentication module 306 displays the authentication form 202 via the graphical user interface 110. The authentication module 306 generates the authentication request 114 in response to authentication data, such as such as a username and/or a password, entered into the authentication via the graphical user interface 110. The authentication module 306 then transmits the authentication request 114 to the server 104 for authentication.

A synchronization module 308 generates and transmits the synchronization request 116 to the server 104 to initiate synchronization of the media presentation data and/or audience profile data between the client 102 and the server 104. As described above, the synchronization of the media presentation data and/or the audience profile data may involve a push/pull synchronization process. According to one aspect, the synchronization module 308 generates and transmits the synchronization request 116 in response to an authentication request 114 that has been validated or authenticated at the server 104.

According to another aspect, the synchronization module 308 generates and transmits the synchronization request 116 in response to user input received via the graphical user interface 110. For example, the user interacts with the graphical user interface 110 to select a synchronization control (not shown) being displayed on the screen.

According to yet another aspect, the synchronization module 308 generates and transmits the synchronization request 116 based on synchronization settings defined by synchronization data 309 stored in the client database 108. For example, the synchronization data defines a schedule or time interval, such as every 2 hours, at which the synchronization module 308 automatically generates the synchronization request 116. In other aspects, synchronization schedule data may also include an indication that indicates whether such automatic synchronization is enabled. The indication may be a flag, yes, no, or some other indication.

A retrieval module 310 retrieves a particular media presentation stored in the client database 108 in response to the presentation request 119 generated at the client 102. In one aspect, as described above, the presentation request 119 is generated in response to the user interacting with the graphical user interface 110 to enter profile data for a particular audience member into the audience member selection form 204. For example, the user can interact with the audience member selection form 204 to search for and/or select a particular audience member. After the user enters profile data (e.g., member name, profession, etc.) to identify a particular audience member via the audience member selection form 204, the retrieval module 310 queries the client database 108 to identify a media presentation associated with the particular audience member. Referring briefly back to FIG. 2B, in this example, the audience member selection form has been used to select a physician named “Lesley Christian.”

A display module 312 displays the media presentation retrieved from the client database 108 via the graphical user interface 110. According to another aspect, the display module 312 displays a presentation history form in response to a presentation history request. The presentation history form includes, for example, the names of audience members, presentation dates, presentation times, and overall scores for each media presentation stored in the client database 108. A screen shot of an exemplary presentation history form 208 is depicted in FIG. 2D.

A scoring module 314 assigns the score to each particular slide of a media presentation based on the feedback input received while that particular slide is being displayed. For example, if a single upward movement of the input tool is detected at the graphical user interface while a first slide is being displayed, the scoring module 314 assigns a score of +5 to the first slide. If a second upward movement of the input tool is detected at the graphical user interface while that same first slide is being displayed, the scoring module 314 assigns a score of +10 to the first slide. As another example, if a single downward movement of the input tool is detected at the graphical user interface while a second slide is being displayed, the scoring module 314 assigns a score of −5 to the second slide. If a second downward movement of the input tool is detected at the graphical user interface 110 while the second slide is being displayed, the scoring module 314 assigns a score of −10 to the second slide. Although the example above is described as assigning scores based on a maximum of two upward movements and/or two downward movements, it is contemplated that in alternative embodiments more than two upward movements and two downward movements can be used to assign scores to slides in a media presentation.

According to another aspect, the scoring module 314 assigns a score to each particular slide of a media presentation based on the number of multiple simultaneous feedback inputs received while that particular slide is being displayed. In one such aspect, multiple feedback inputs can be generated based on the simultaneous directional movement of multiple input tools, such as a multiple finger gesture, at the graphical interface. For example, if a single finger upward gesture (i.e., upward movement of the finger) is detected at the graphical user interface while a first slide is being displayed, the scoring module 314 assigns a score of +5 to the first slide. If a two simultaneous finger upward gesture is detected at the graphical user interface while that same first slide is being displayed, the scoring module 314 assigns a score of +10 to the first slide. As another example, if a single finger downward gesture is detected at the graphical user interface while a second slide is being displayed, the scoring module 314 assigns a score of −5 to the second slide. If a two simultaneous finger downward gesture is detected at the graphical user interface 110 while the second slide is being displayed, the scoring module 314 assigns a score of −10 to the second slide.

Although the example above is described as assigning scores based on a maximum of two simultaneous finger upward gestures and/or two simultaneous finger downward gestures, it is contemplated that in alternative embodiments more than two finger upward gestures and two finger downward gestures can be used to assign scores to slides in a media presentation. It is also contemplated that in other aspects, that a positive score may be assigned to a slide based on the directional movement of an input tool that is not upward and a negative score may be assigned to the slide based on the directional movement of an input tool that is not downward. For example, in another aspect, when a single finger downward gesture is detected at the graphical user interface while a first slide is being displayed, the scoring module 314 assigns a score of +5 to the first slide. Alternatively, when a single finger upward gesture is detected at the graphical user interface while a first slide is being displayed, the scoring module 314 assigns a score of −5 to the first slide.

According to another aspect, the user of the client may interact with the graphical user interface 110 to specify which directional movement of the input tool results in a positive score, which directional movement of the input tool results in a negative score, and/or the magnitude of the score (e.g., value) that is associated with each detected movement or gesture. For example, settings input form (not shown) to define directional movement of the input tool that results in a positive score and/or the magnitude of the score.

According to another aspect, the scoring module 314 also assigns an overall score to a media presentation based on the scores assigned to each of the individual slides in that media presentation. In one aspect, the overall score of the media presentation corresponds to an average of the scores assigned to each of the individual slides in that media presentation. For example, different media presentations for a particular topic may each have five slides and two of those slides may have received feedback input while being displayed. In one of the media presentations, one slide may have been assigned a +5 and the other slide may have been assigned a +10. In the other media presentation, the same slides may have each been assigned +10. As a result, the overall score of the former media presentation corresponds to an average of +7.5. The overall score of the latter media presentation corresponds to an average of +10.

In another aspect, the overall score of the media presentation corresponds to a sum of the scores assigned to each of the individual slides in that presentation. As a result, in the first example above the overall score of media presentation corresponds to a sum of +15. In the second example, the overall score of the media presentation corresponds to a sum of +20. The examples above are provided for illustration purposes, it is contemplated that the overall score assigned to a media presentation may be calculated using other techniques.

A storage module 316 stores media presentation data 318 and audience profile data 320 received from the server during the synchronization process 118 in the client database 108. The storage module 316 also stores scores assigned to individual slides in a media presentation and the overall scores assigned to media presentations in the client database 108. The storage module 316 can also store updated profile data in response to input received at the graphical user interface. For example, the user interacts with the graphical user interface 110 to select audience profile data, such as contact data, to modify via the audience member selection form 204.

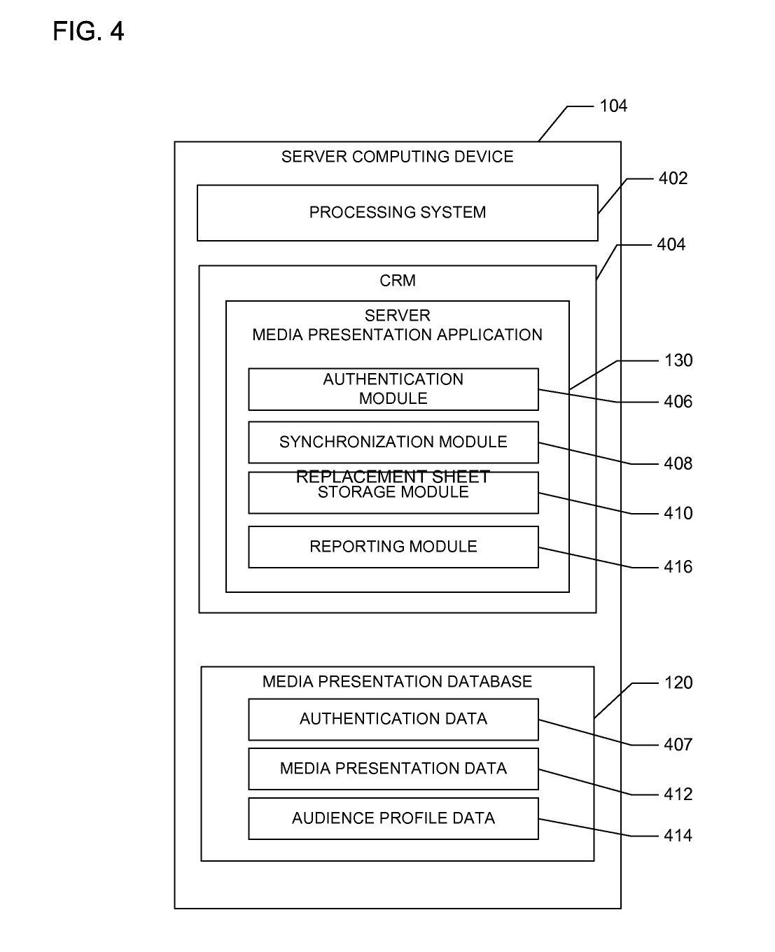

FIG. 4 is a block diagram that depicts an exemplary server MPA 130. According to one aspect, the server 104 includes a processing system 402 that includes one or more processors. The processing system 402 executes the server MPA 130 to store, transfer, and/or manage media presentation data.

According to one aspect, the server 104 includes a computer readable medium 404 configured with the server MPA 130. The server MPA 130 includes instructions or modules that are executable by the processing system 402 to synchronize media presentation data and audience profile data between the client 102 and the server 104 and to manage media presentations data and profile data in the server database 120.

The computer readable medium (CRM) 404 may include volatile media, nonvolatile media, removable media, non-removable media, and/or another available medium that can be accessed by the server 104. By way of example and not limitation, computer readable medium 404 comprises computer storage media and communication media. Computer storage media includes memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system.

An authentication module 406 queries valid authentication data 407 stored in the server database 120 to determine if a user has provided valid authentication data via the authentication request 114. For example, the server MPA 130 queries the server database 120 to determine if a username and/or a password include in the authentication request 114 matches any valid usernames and/or passwords stored in the server database 120. If no match is identified, the authentication module 406 generates and transmits a message to the client 102 that indicates the authentication data is invalid. If a match is identified, the authentication module 406 designates the authentication request 114 as authentic and/or valid.

A synchronization module 408 receives the synchronization request 116 from the client 102 and initiates the synchronization process 118 to synchronize the media presentation data and/or audience profile data between the client 102 and the server 104. According to one aspect, the synchronization module 408 initiates a push/pull data synchronization process 118 as described above in connection with FIG. 1.

A storage module 410 stores updated media presentation data 412 and updated audience profile data 414 received from the client 102 during the synchronization process 118 in the server database 120. The storage module 408 also stores updated profile data 414 in response to the update request 124 received from the administrator user interface 122. For example, the update request is generated when the administrative user interacts with the administrative input form (not shown) via the administrator user interface 122 and selects a particular media presentation in the server database 120 from which to delete, replace, or add one or more slides. As another example, the update request 124 is generated when the administrative user interacts with the administrator user interface 122 to identify a new media presentation to store in the server database 120. As yet another example, the update request 124 is generated when the administrative user interacts with the administrator user interface 122 via the administrative input form (not shown) to modify and/or add audience profile data, such as contact data.

A reporting module 416 generates a report that includes media presentation data for one or more advertisements in response to the report request 132 received form the administrative user via administrator user interface 122. As described above, the report may include scores assigned to pages in media presentations and overall scores of media presentations. Upon evaluating the scores assigned to individual slides and overall scores included in a report for a particular media presentation, the administrative user or other interested party can determine whether the content (i.e., pages) included in a particular media presentation should be modified.

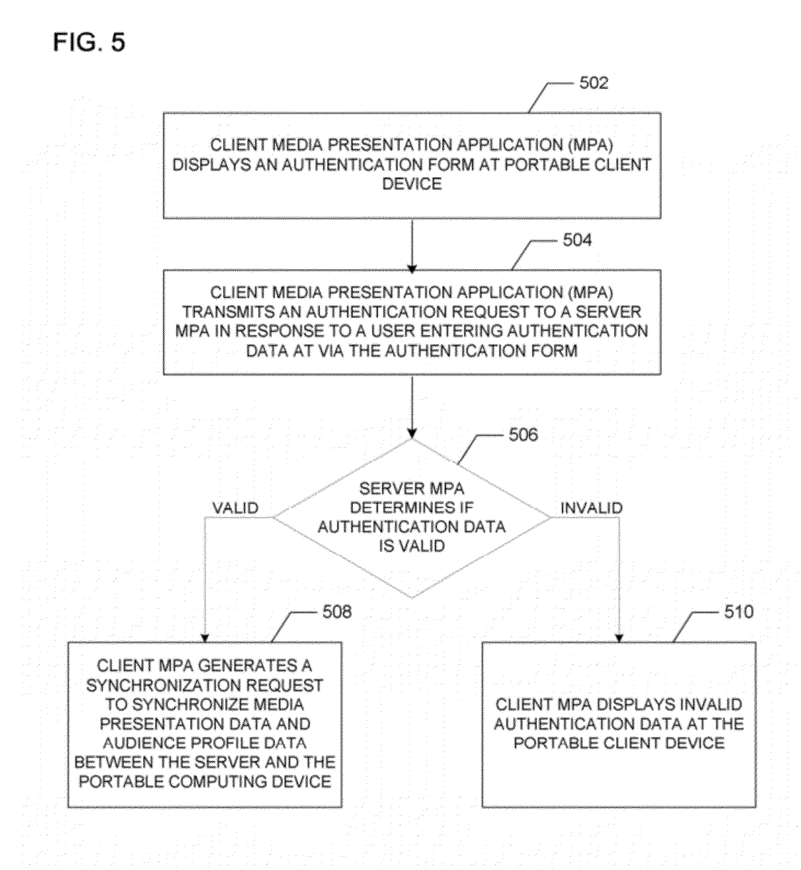

FIG. 5 illustrates a method for initiating a synchronization process 118 in accordance with an aspect of the client MPA 112. At 502, the client MPA 112 executes at the client and displays an authentication form 202 to a user via a graphical user interface 110. The client MPA 112 transmits an authentication request 114 to a server 104 executing a server MPA 130 in response to authentication data entered by a user into the authentication form 202 via the graphical user interface 110 at 504. At 506, the server MAP 130 determines if the authentication data entered by the user corresponds to valid authentication data. If the authentication data is determined valid at 506, the client MPA 112 generates a synchronization request 116 to synchronize media presentation data and audience profile data stored on the client 102 with media presentation data and audience profile data stored on the server 104 at 508. If the authentication data is determined invalid at 506, the client MPA 112 displays a message that indicates the authentication is invalid via the graphical user interface 110 at 510.

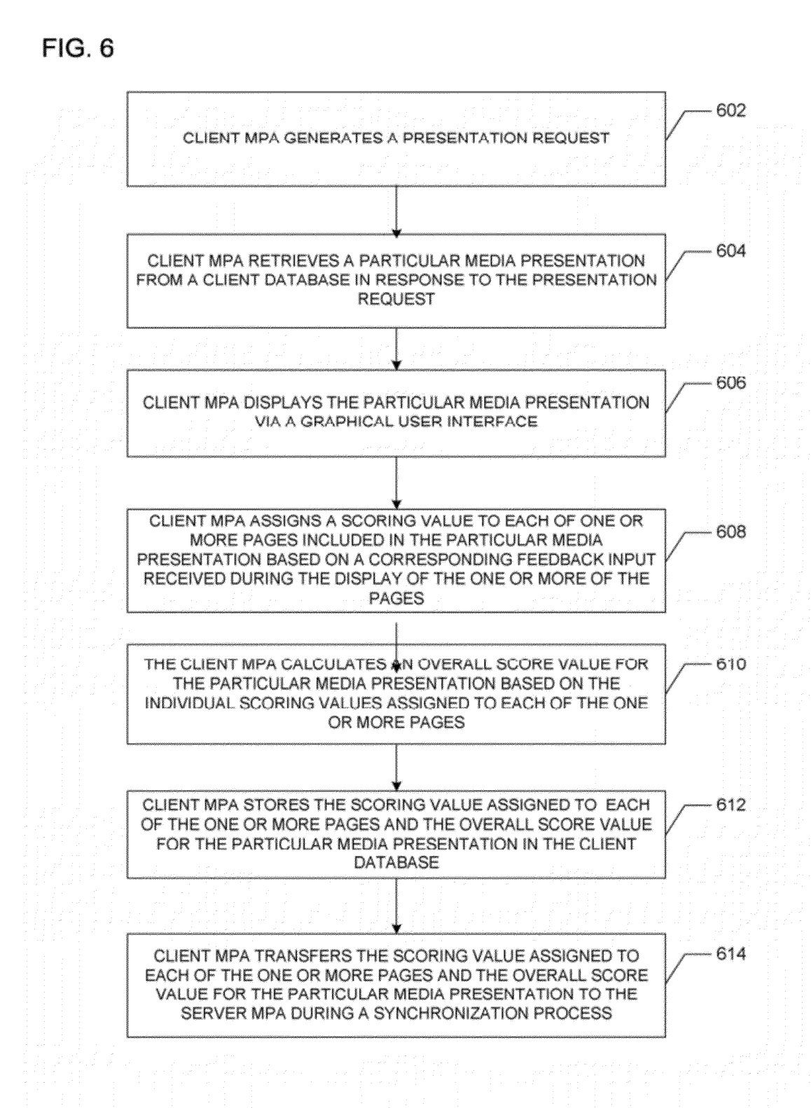

FIG. 6 illustrates a method for displaying and scoring a media presentation in accordance with an aspect of the client MPA 112. At 602, the client MPA 112 generates a presentation request in response to audience profile data entered into the audience member selection form 204 for a particular audience member via the graphical user interface 110. The client MPA 112 retrieves a particular media presentation from the client database 108 based on the audience profile data associated with the presentation request 119 at 604. At 606, the client MPA 112 displays the particular media presentation via the graphical user interface 110. The client MPA 112 assigns a score, to each of one or more slides included the particular media presentation based on a corresponding feedback input received at the graphical user interface 110 during the display of the one or more slides at 608. Optionally, at 610, the client MPA 112 calculates an overall score for the particular media presentation based on the individual scores assigned to one or more slides included in the particular media presentation. The client MPA 112 stores scores assigned to each of the one or more pages for the particular media presentation in the client database 108 at 612. At 614, the client MPA 112 transfers the scores assigned to each of the one or more pages for the particular media presentation and/or the overall score for the particular media presentation during the synchronization process 118 at 612.

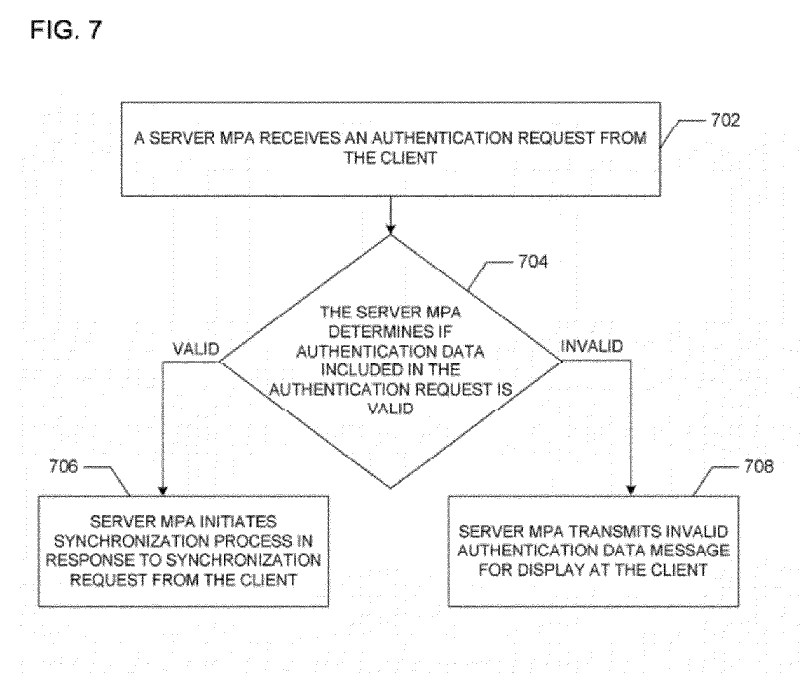

FIG. 7 illustrates an exemplary method for initiating a synchronization process between the client 102 and server 104 in accordance with an aspect of the server MPA 130. At 702, the server MPA 160 receives the authentication request 114 that includes authentication data for a particular user from the client 102. The server MPA 130 queries valid authentication data stored in the server database 120 to determine if the authentication data included in the authentication request 114 is valid at 704. If the authentication data is determined valid at 704, the server MPA 130 initiates the synchronization process 118 to synchronize media presentation data and audience profile data stored on the server 104 with media presentation data and audience profile data stored on the client 102 at 706. If the authentication data is determined invalid at 704, the server MPA 130 transmits an invalid data message to the client 102 at 708.

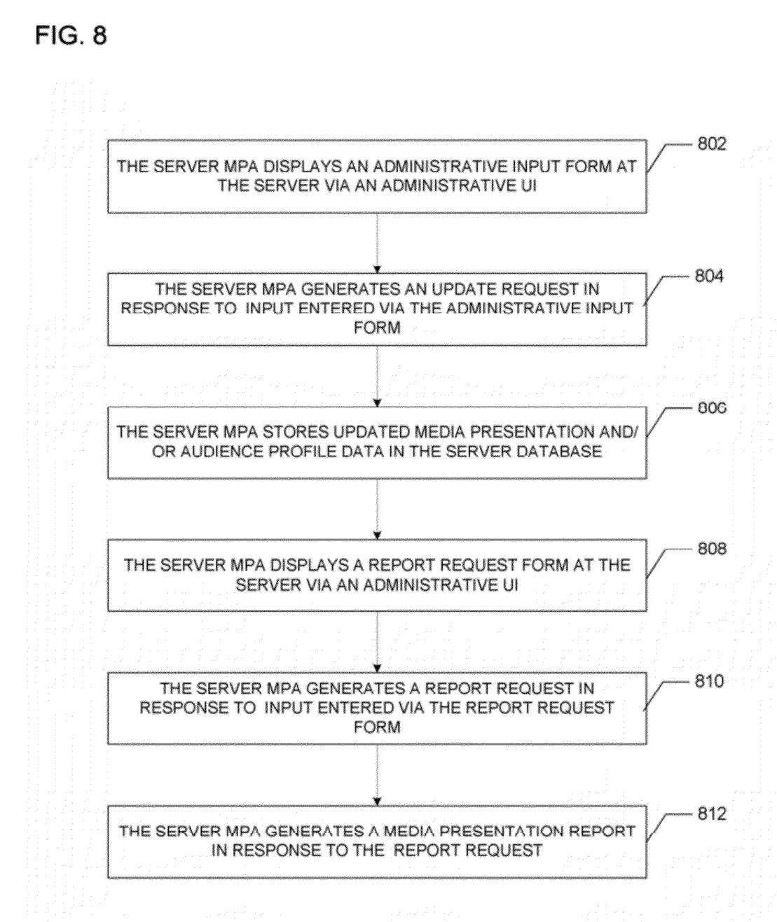

FIG. 8 illustrates an exemplary method for managing media presentation data and/or audience profile data in accordance with an aspect of the server MPA 130. At 802, the server MPA 130 displays an administrative input form to an administrative user via the administrative UI 122. The server MPA 130 generates an update request 124 in response to input entered into the administrative input form via the administrator UI 122 at 804. At 806, the server MPA 130 stores updated media presentation data and/or audience profile data in the server database 120 in response to the update request 124 received from the administrator UI 122.

At 808, the server MPA 130 displays a report request form to an administrative user via the administrative UI 122. The server MPA 130 generates the report request in response to input entered into the report request form via the administrator UI 122 at 810. At 720 the server MPA 130 generates the media presentation report in response to the report request 132 received from the administrator user interface 122 at 812.

Those skilled in the art will appreciate that variations from the specific embodiments disclosed above are contemplated by the invention. The invention should not be restricted to the above embodiments, but should be measured by the following claims.

1. A portable computing device encoded with a media presentation application comprising modules executable by a processor and configured to rank content in a media presentation, the media presentation application comprising:
a retrieval module to retrieve a media presentation stored in a database in response to a presentation request generated at the portable computing device, the media presentation comprising a plurality of pages each comprising content, and the presentation request comprising identification data corresponding to the media presentation;
a display module to display each of the plurality of pages of the media presentation via a graphical interface of the portable computing device;
a scoring module to assign a score to at least one of the plurality of pages of the media presentation in response to a feedback input received at the graphical interface while the at least one of the plurality of pages is being displayed, the feedback input specifying the score for the at least one of the plurality of pages and corresponding to a directional movement of an input tool at the graphical interface;
a storage module to store the score assigned to the at least one of the plurality of pages in the database; and
a synchronization module to transmit the score assigned to the at least one of the plurality of pages to a remote computing device in response to a synchronization request generated at the portable computing device.

2. The portable computing device of claim 1 wherein a first movement of the input tool in a first direction at the graphical interface specifies a positive score, wherein a second movement of the input tool in the first direction specifies a greater positive score, wherein another first movement of the input tool in a second direction specifies a negative score, and wherein another second movement of the input tool in the second direction specifies a lower negative score.

3. The portable computing device of claim 2 wherein the input tool is at least one member selected from a group consisting of a stylus and at least one finger.

4. The portable computing device of claim 3 wherein a single finger movement in the first direction at the graphical interface corresponds to the positive score, wherein a two finger movement in the first direction at the graphical interface corresponds to the greater positive score, wherein another single finger movement in the second direction at the graphical interface corresponds to a negative score, and wherein another two finger movement in the second direction at the graphical interface corresponds a lower negative score.

5. The portable computing device of claim 2 wherein the feedback input corresponds to a selection of an input control displayed at the graphical interface, wherein a first selection of a first input control specifies the positive score, wherein a second selection of the first input control corresponds to the greater positive score, wherein another first selection of a second input control specifies the negative score, and wherein another second selection of the second input control specifies the lower negative score.

6. The portable computing device of claim 1 wherein the portable computing device is at least one member selected from a second group consisting of a lap top computer, a personal digital assistant, and a portable media player.

7. The portable computing device of claim 1 wherein content comprises at least one of image data, text data, and graphic data.

8. The portable computing device of claim 1 wherein the synchronization module transmits the score via a communication link selected from a third group consisting of a wired connection and a wireless communication link.

9-14. (canceled)

15. A computer-readable medium encoded with a media presentation application comprising modules executable by a processing device to rank content in a media presentation, the media presentation application comprising:
a retrieval module to retrieve a media presentation stored in a database in response to a presentation request generated at the processing device, the media presentation comprising a plurality of pages each comprising content, and the presentation request comprising identification data corresponding to the media presentation;
a display module to display each of the plurality of pages of the media presentation via a graphical interface of the processing device;
a scoring module to rank at least one of the plurality of pages of the media presentation in response to a feedback input received at the graphical interface while the at least one of the plurality of pages is being displayed, the feedback input specifying a score and corresponding to a directional movement of an input tool at the graphical interface;
a storage module to store the score assigned to the at least one of the plurality of pages in the database; and
a synchronization module to transmit the score assigned to the at least one of the plurality of pages to a remote computing device in response to a synchronization request generated at the processing device.

16. The computer-readable medium of claim 15 wherein a first movement of the input tool in a first direction at the graphical interface specifies a positive score, wherein a second movement of the input tool in the first direction specifies a greater positive score, wherein another first movement of the input tool in a second direction specifies a negative score, and wherein another second movement of the input tool in the second direction specifies a lower negative score.

17. The computer-readable medium of claim 16 wherein the input tool is at least one member selected from a group consisting of a stylus and a finger.

18. The computer-readable medium of claim 15 wherein a single finger movement in the first direction at the graphical interface corresponds to the positive score, wherein a two finger movement in the first direction at the graphical interface corresponds to the greater positive score, wherein another single finger movement in the second direction at the graphical interface corresponds to a negative score, and wherein another two finger movement in the second direction at the graphical interface corresponds a lower negative score.

19. The computer-readable medium of claim 15 wherein the processing device is at least one member selected from a second group consisting of a personal computer, a lap top computer, a personal digital assistant, and a portable media player.

20. The computer-readable medium of claim 15 wherein content comprises at least one of image data, text data, and graphic data.

21. The computer-readable medium of claim 15 wherein the synchronization module transmits the score via a communication link selected from a third group consisting of a wired connection and a wireless communication link.

22. A method for ranking content in a media presentation, the method comprising:
generating a presentation request at a computing device, the presentation request comprising identification data corresponding to a media presentation;
retrieving the media presentation from a database in response to the presentation request, the media presentation comprising a plurality of pages each comprising content,
displaying each of the plurality of pages of the media presentation via a graphical interface of the computing device;
receiving a feedback input at the graphical interface while a particular one of least one of the plurality of pages is being displayed, the feedback input specifying a score for that particular one of the pages and corresponding to a directional movement of an input tool at the graphical interface;
storing the score specified for the particular one of the pages in the database; and
transmitting the score for the particular one of the pages to a server in response to a synchronization request generated at the computing device.

23. The method claim 22 wherein receiving a first movement of the input tool in a first direction at the graphical interface specifies a positive score, wherein receiving a second movement of the input tool in the first direction specifies a greater positive score, wherein receiving another first movement of the input tool in a second direction specifies a negative score, and wherein receiving another second movement of the input tool in the second direction specifies a lower negative score.

24. The method of claim 22 wherein the input tool is at least one member selected from a group consisting of a stylus and a finger.

25. The method claim 24 wherein receiving a single finger movement in the first direction at the graphical interface specifies the positive score, wherein receiving a two finger movement in the first direction at the graphical interface specifies the greater positive score, wherein receiving another single finger movement in the second direction at the graphical interface specifies a negative score, and wherein receiving another two finger movement in the second direction at the graphical interface specifies a lower negative score.

26. The method of claim 22 wherein the computing device is at least one member selected from a second group consisting of a personal computer, a lap top computer, a personal digital assistant, and a portable media player.

27. The method of claim 22 wherein content comprises at least one of image data, text data, and graphic data.

28. The method of claim 22 wherein transmitting the score comprises transmitting the score via a communication link selected from a third group consisting of a wired connection and a wireless communication link.
